(19) United States
(12) Patent Application Publication
(10) Pub. No.: US 2017/0342348 A1
(43) Pub. Date: Nov. 30, 2017

(54) DETERGENTS AND CLEANING AGENTS COMPRISING A COMBINATION OF AMYLASE AND PROTEASE

(71) Applicant: Henkel AG & Co. KGaA, Duesseldof (DE)

(72) Inventors: Marouane Antir, Hilversum (NL); Sabine Schuemann, Neuss (DE); Thorsten Bastigkeit, Wuppertal (DE); Martina Seiler, Duisburg (DE); Timothy O'Connell, Landsberg am Lech (DE)

(73) Assignee: Henkel AG & Co. KGaA, Duesseldorf (DE)

(21) Appl. No.: 15/534,753

(22) PCT Filed: Dec. 1, 2015
(86) PCT No.: PCT/EP2015/078166

§ 371 Date: Jun. 9, 2017

(30) Foreign Application Priority Data
Dec. 10, 2014 (DE) 10 2014 225 473.6

(51) Int. Cl. C11D 3/386

(52) U.S. Cl. CPC C11D 3/386; C12Y 302/01001; C12Y 304/21062

(57) ABSTRACT

The disclosure relates to detergents and cleaning agents containing a combination of protease and amylase, the amino acid sequence of which has been modified specifically for use in detergents and cleaning agents. The disclosure further relates to methods and uses of said detergents and cleaning agents.

### CROSS-REFERENCE TO RELATED APPLICATION

This application is a U.S. National-Stage entry under 35 U.S.C. §371 based on International Application No. PCT/EP2015/078166, filed Dec. 1, 2015 which was published under PCT Article 21(2) and which claims priority to German Application No. 10 2014 225 473.6, filed Dec. 10, 2014, which are all hereby incorporated in their entirety by reference.

### TECHNICAL FIELD

The disclosure relates to a washing and cleaning agent, comprising an enzyme combination of an amylase and a protease, the amino acid sequences of which were modified in particular with respect to the use in washing and cleaning agents, and all sufficiently similar amylases and protease having a corresponding modification. The disclosure furthermore relates to methods and uses of these washing and cleaning agents.

### BACKGROUND

Proteases are some of the technically most significant enzymes. They are the enzymes that have been established the longest for washing and cleaning agents and can practically be found in all modern, powerful washing and cleaning agents. They cause protein-containing soiling on the goods to be cleaned to break down. Among these, in turn, proteases of the subtilisin type (subtilases, subtilopeptidases, EC 3.4.21.62) are particularly important, which due to the catalytically active amino acids are serine proteases. They act as non-specific endopeptidases and hydrolyze arbitrary acid amide bonds that lie in the interior of peptides or proteins. The pH optimum of these is usually in the distinctly alkaline range. An overview of this family can be found, for example, in the article “Subtilases: Subtilisin-like Proteases” by R. Siezen, pages 75-95 in “Subtilisin enzymes,” published by R. Bott and C. Betzel, New York, 1996. Subtilases are formed naturally from microorganisms. Among these, in particular the subtilisins formed and secreted by the Bacillus species shall be mentioned as the most significant group within the subtilases.

Examples of the proteases of the subtilisin type preferably used in washing and cleaning agents are the subtilisins BPN' and Carlsberg, the protease PB92, the subtilisins 147 and 309, the protease from Bacillus lentus, and in particular from Bacillus lentus DSM 5483, subtilisin DY, and the thermitase enzymes, which can be assigned to the subtilases, but not to the subtilisins in the narrower sense, proteinase K, and the proteases TW3 and TW7, and variants of the described proteases which have a modified amino acid sequence compared to the starting protease. Proteases are modified deliberately or randomly using methods known from the prior art and thus optimized for the use in washing and cleaning agents, for example. These include point mutagenesis, deletion or insertion mutagenesis, or fusion with other proteins or protein fragments. Appropriately optimized variants are known for the majority of proteases known from the prior art.

Further enzymes that can be used in washing and cleaning agents are amylases. Synonymous terms can be used for amylases, such as 1,4-alpha-D-glucan-glucanohydrolase or glycogenase. The α-amylases are preferred amylases as contemplated herein. The decisive factor as to whether an enzyme is an α-amylase as contemplated herein is the capability thereof to carry out the hydrolysis of α(1,4)-glycosidic linkages in the amylose of the starch.

Amylases known in the prior art and, in particular, also the improved further developments thereof for use in washing or cleaning agents, are described hereafter. The α-amylase from Bacillus licheniformis (available as Termamyl® from Novozymes or as Purasta®ST from Danisco/Genencor) and the further development products thereof Duramyl® and Termamyl®ultra (Novozymes), Purastar®OxAm (Danisco/Genencor) and Keistase® (Daiwa Seiko Inc.), and the α-amylases from Bacillus amyloliquefaciens or from Bacillus stearothermophilus are suitable amylases. The α-amylase from Bacillus amyloliquefaciens is sold by Novozymes by the name BAN®, and derived variants of the α-amylase from B. stearothermophilus are available by the names BSG® and Novamyl®, likewise from Novozymes. Further known amylases are the α-amylase from Bacillus sp. A 7-7 (DSM 12368) and the cyclodextrin glucanotransferase (CGTase) from Bacillus agaradherens (DSM 9948), as well as the further developments of the α-amylase from Aspergillus niger or A. oryzae available from Novozymes under the trade name Fungamyl®. Further commercial products that can advantageously be used in washing and cleaning agents are, for example the Amylase LT® and Stainzyme® or Stainzyme ultra® or Stainzyme plus®, the latter likewise being available from Novozymes. It is also possible to use variants of these enzymes obtained by way of point mutations in washing and cleaning agents. Particularly preferred amylases are disclosed in the international unexamined patent applications WO 00/60060, WO 03/002711, WO 03/054177 and WO07/079938, the disclosure of which is hereby expressly referenced or the disclosure of which in this regard is expressly incorporated in the present patent application by reference.

### BRIEF SUMMARY

A washing or cleaning agent is provided herein. The washing or cleaning agent includes an α-amylase and a protease, wherein the α-amylase is at least about 89% identical to the sequence indicated in SEQ ID NO. 1 over the entire length thereof and, in the numbering according to SEQ ID NO. 1, has deletions at one or more of positions 180, 181, 182, 183 and 184.

### DETAILED DESCRIPTION

The following detailed description is merely exemplary in nature and is not intended to limit the disclosure or the application and uses of the subject matter as described herein. Furthermore, there is no intention to be bound by any theory presented in the preceding background or the following detailed description.

Surprisingly, it has now been found that an α-amylase as contemplated herein improves the stability and the performance of a protease in a washing and cleaning agent.

The subject matter of the present disclosure is thus a washing and cleaning agent, comprising a combination of an α-amylase and a protease, wherein the α-amylase is characterized by being at least about 89%, and increasingly preferably at least about 90%, about 90.5%, about 91%, about 91.5%, about 92%, about 92.5%, about 93%, about 93.5%, about 94%, about 94.5%, about 95%, about 95.5%, about 96%, about 96.5%, about 97%, about 97.5%, about 98%, about 98.5%, about 99%, about 99.5% and up to 100% identical to the sequence indicated in SEQ ID NO. 1 over the entire length thereof and, in the numbering according to SEQ ID NO. 1, has a deletion at one or more of positions 180, 181, 182, 183 and 184.

Particularly preferred is a deletion of two positions, selected from 180+181, 181+182, 182+183 and 183+184, and especially particularly preferred are deletions at positions 183+184, in the numbering according to SEQ ID NO. 1, and in particular the deletions H183*+G184* are preferred.

In the numbering according to SEQ ID NO. 1, the α-amylase as contemplated herein furthermore has an amino acid substitution at one or more of positions 405, 421, 422 and 428. The substitutions 1405L, A421H, A422P and A428T are particularly preferred.

In a particularly preferred embodiment, the α-amylase as contemplated herein has the deletions H183*+G184*, and additionally the substitutions 1405L, A421H, A422P and A428T, in the numbering according to SEQ ID NO. 1.

The protease as contemplated herein comprises an amino acid sequence that is at least 80%, and increasingly preferably at least about 81%, about 82%, about 83%, about 84%, about 85%, about 86%, about 87%, about 88%, about 89%, about 90%, about 90.5%, about 91%, about 91.5%, about 92%, about 92.5%, about 93%, about 93.5%, about 94%, about 94.5%, about 95%, about 95.5%, about 96%, about 96.5%, about 97%, about 97.5%, about 98%, about 98.5%, about 99% or about 100% identical to the amino acid sequence indicated in SEQ ID NO. 2 and/or in SEQ ID NO. 3 over the total length thereof.

A preferred protease is one that includes an amino acid sequence that is at least 80%, and increasingly preferably at least about 81%, about 82%, about 83%, about 84%, about 85%, about 86%, about 87%, about 88%, about 89%, about 90%, about 90.5%, about 91%, about 91.5%, about 92%, about 92.5%, about 93%, about 93.5%, about 94%, about 94.5%, about 95%, about 95.5%, about 96%, about 96.5%, about 97%, about 97.5%, about 98%, about 98.5%, about 99% identical to the amino acid sequence indicated in SEQ ID NO. 2 over the total length thereof and comprises the amino acid glutamic acid (E) at position 99.

A protease according to SEQ ID NO. 4 is particularly preferred.

Amino acid positions that, within the scope of the present disclosure, are indicated by the expression “numbering according to SEQ ID NO. 1” shall be understood to mean the following: The further amino acid positions are defined by an alignment of the amino acid sequence of an amylase or a protease as contemplated herein with the amino acid sequence as it is indicated in SEQ ID NO. 1. The assignment of the positions is furthermore dependent on the mature protein. This assignment should, in particular, also be used when the amino acid sequence of a protein as contemplated herein comprises a higher number of amino acid residues than the amylase or protease in SEQ ID NO. 1. Proceeding from the described positions in the amino acid sequence, the modification positions in an amylase or a protease as contemplated herein are those which are assigned to these very positions in an alignment.

The combination as contemplated herein of an α-amylase as contemplated herein with a protease in washing and cleaning agents brings about improved cleaning performance of the washing and cleaning agent on at least one protease-sensitive stain. The α-amylases as contemplated herein have a performance-enhancing effect on the protease likewise present in the washing and cleaning agent, and consequently, among other things due to the protease-stabilizing action thereof, enable improved removal of at least one, and preferably of multiple, protease-sensitive stains on textiles and/or hard surfaces, such as dishes. Particularly preferred cleaning performance is exhibited by preferred embodiments of washing and cleaning agents as contemplated herein on stains containing blood, such as the blood/milk/ink stain: product No. CFT C-05, available from CFT (Center For Testmaterials) B. V. Viaardingen, Netherlands.

As a result of preferred embodiments of the present disclosure, washing and cleaning agents having improved cleaning performance are produced deliberately with respect to protease-sensitive soiling.

Preferred embodiments of amylase and protease combinations as contemplated herein also already achieve this advantageous cleaning performance at low temperatures, and in particular in the temperature ranges between about 10° C. and about 60° C., preferably between about 15° C. and about 50° C., and particularly preferably between about 20° C. and about 40° C. Further preferred embodiments of amylase and protease combinations as contemplated herein achieve this advantageous cleaning performance in a wide temperature range, for example between about 15° C. and about 90° C., and preferably between about 20° C. and about 60° C.

Cleaning performance as contemplated herein shall be understood to mean the lightening performance on one or multiple stains, in particular on laundry or dishes. As contemplated herein, both the washing or cleaning agent that comprises the combination of amylase and protease, or the washing or cleaning liquor formed by this agent, and the protease and amylase themselves exhibit a particular cleaning performance. The cleaning performance of the enzymes thus contributes to the cleaning performance of the agent, or of the washing or cleaning liquor formed by the agent. The cleaning performance is preferably ascertained as described hereafter.

For the present disclosure, primarily the cleaning performance of the protease will be highlighted, wherein the synergistic effect of the a amylase as contemplated herein is pointed out indirectly by the improved cleaning performance of the protease on protease-containing stains.

A protease exhibits proteolytic activity, which is to say it is capable of the hydrolysis of peptide bonds of a polypeptide or protein, in particular in a washing or cleaning agent. A protease is thus an enzyme that catalyzes the hydrolysis of peptide bonds, and thus is able to cleave peptides or proteins. The amylases and proteases as contemplated herein are preferably the mature amylase/protease, which is to say the catalytically active molecule having no signal peptide(s) and/or propetide(s). Unless indicated otherwise, the indicated sequences each also refer to mature enzymes.

The identity of nucleic acid or amino acid sequences is determined by a sequence comparison. This sequence comparison is based on the BLAST algorithm that is established in the prior art and customarily used (see, for example, Altschul, S. F., Gish, W., Miller, W., Myers, E. W. & Lipman, D. J. (1990) “Basic local alignment search tool.” J. Mol. Biol. 215:403-410, and Altschul, Stephan F., Thomas L. Madden, Alejandro A. Schaffer, Jinghui Zhang, Hheng Zhang, Webb Miller, and David J. Lipman (1997): “Gapped BLAST and PSI-BLAST: a new generation of protein database search programs”; Nucleic Acids Res., 25, pp. 3389-3402) and is essentially carried out by assigning similar successions of nucleotides or amino acids in the nucleic acid sequences or amino acid sequences to each other. A tabular assignment of the particular positions is referred to as an alignment. Another algorithm available in the prior art is the FASTA algorithm. Sequence comparisons (alignments), in particular multiple sequence comparisons, are created using computer programs. For example, the Clustal series (see, for example, Chenna et al. (2003): Multiple sequence alignment with the Clustal series of programs. Nucleic Acid Research 31, 3497-3500), T-Coffee (see, for example, Notredame et al. (2000): T-Coffee: A novel method for multiple sequence alignments. J. Mol. Biol. 302, 205-217) or programs that are based on these programs or algorithms are frequently used. In the present patent application, all sequence comparisons (alignments) were carried out using the computer program Vector NTI® Suite 10.3 (Invitrogen Corporation, 1600 Faraday Avenue, Carlsbad, Calif., USA) using the predefined standard parameters, the AlignX module of which for the sequence comparisons is based on ClustalW.

Such a comparison also allows information to be provided about the similarity of the compared sequences among each other. It is customarily indicated in percent identity, which is to say the proportion of identical nucleotides or amino acid residues at the same positions or at positions corresponding to each other in an alignment. The broader concept of homology, in the case of amino acid sequences, takes conservative amino acid exchanges into consideration, which is to say amino acids having similar chemical activity, since these generally carry out similar chemical activities within the protein. The similarity of the compared sequences may thus also be indicated in percent homology or percent similarity. Identity and/or homology information can be provided for entire polypeptides or genes, or only for individual regions. Homologous or identical regions of different nucleic acid or amino acid sequences are therefore defined by agreements in the sequences. Such regions often have identical functions. They may be small and comprise only few nucleotides or amino acids. Such small regions often carry out functions that are essential for the overall activity of the protein. It may therefore be useful to relate sequence agreements only to individual, optionally small regions. Unless indicated otherwise, however, identity or homology information in the present application refers to the entire length of the respective indicated nucleic acid or amino acid sequence.

The cleaning performance is determined in a washing system comprising a washing agent in a dose between about 3.5 and about 6.5 grams per liter of washing liquor and the protease and the amylase. The amylases to be compared are used in the same concentrations (based on active protein). The cleaning performance of the protease with respect to a blood stain is determined by measuring the degree of whiteness of the washed textiles. The washing process takes place for 70 minutes at a temperature of 40° C., wherein the water has a hardness between about 13.5 and about 16.5° (German degree of hardness).

The concentration of the protease in the washing agent intended for this washing system is from about 0.001 to about 0.1 wt. %, and preferably from about 0.01 to about 0.06 wt. %, based on active protein. The concentration of the amylase in the washing agent intended for this washing system is from about 0.001 to about 0.15 wt. %, and preferably from about 0.005 to about 0.012 wt. %, based on active protein.

A preferred liquid washing agent for such a washing system has the following composition (all information in percent by weight): from about 0.3 to about 0.5% xanthan gum, from about 0.2 to about 0.4% anti-foaming agent, from about 6 to about 7% glycerol, from about 0.3 to about 0.5% ethanol, from about 4 to about 7% FAEOS (fatty alcohol ether sulfate), from about 5 to about 15% non-ionic surfactants, from about 5 to about 15% anionic surfactants (LAS), 1% boric acid, from about 1 to about 4% sodium citrate (dihydrate), from about 2 to about 4% soda, from about 2 to about 6% coconut fatty acids,from about 0.5 to about 2.5% HEDP (1-hydroxyethane-(1,1-diphosphonate)), from about 0 to about 0.4% PVP (polyvinylpyrrolidone), from 0 to about 0.15% optical brighteners, from 0 to about 0.001% dye, the remainder being demineralized water. The dose of the liquid washing agent is preferably between about 3.5 and about 6.0 grams per liter of washing liquor, for example 4.7, 4.9 or 5.9 grams per liter of washing liquor. The washing process preferably takes place in a pH value range between about pH 8 and about pH 10.5, and preferably between about pH 8 and about pH 9.

A preferred powdered washing agent for such a washing system has the following composition (all information in percent by weight): about 10% linear alkylbenzene sulfonate (sodium salt), about 1.5% C12-C18 fatty alcohol sulfate (sodium salt), about 2.0% C12-C18 fatty alcohol having 7 EO, about 20% sodium carbonate, about 6.5% sodium hydrogen carbonate, 4.0% amorphous sodium silicate, about 17% sodium carbonate peroxohydrate, about 4.0% TAED, about 3.0% polyacrylate, about 1.0% carboxymethyl cellulose, about 1.0% phosphonate, about 27% sodium sulfate, the remainder being: suds suppressors, optical brighteners and fragrances. The dose of the powdered washing agent is preferably between about 4.5 and about 7.0 grams per liter of washing liquor, for example and particularly preferably about 4.7 grams per liter of washing liquor, or about 5.5, about 5.9 or about 6.7 grams per liter of washing liquor. The washing process preferably takes place in a pH value range between about pH 9 and about pH 11.

The degree of whiteness, which is to say the lightening of the stains, as a measure of the cleaning performance, is preferably determined by way of optical measurement methods, and preferably photometrically. One device that is suitable for this purpose, for example, is the Minolta CM508d spectrometer. The devices used for the measurement are usually first calibrated using a white standard, and preferably a supplied white standard.

The protein concentration can be determined using known methods, such as the BCA method (bicinchoninic acid; 2,2′-biquinoline-4,4′-dicarboxylic acid) or the biuret method (A. G. Gornall, C. S. Bardawill and M. M. David, J. Biol. Chem., 177 (1948), pp. 751-766). The active protein concentration can be determined in this regard by a titration of the active centers using a suitable irreversible inhibitor (for proteases, for example, phenylmethylsulfonyl fluoride (PMSF)) and determination of the residual activity (see M. Bender et al., J. Am. Chem. Soc. 88, 24 (1966), pp. 5890-5913).

In addition to the above-described amino acid modifications, amylases and proteases as contemplated herein can have further amino acid modifications, and in particular amino acid substitutions, insertions or deletions. Such amylases and proteases are further developed, for example, by targeted genetic modification, which is to say by way of mutagenesis methods, and optimized for certain usage purposes or with respect to specific properties (for example with respect to the catalytic activity thereof, stability and the like). Furthermore, it is possible to introduce nucleic acids as contemplated herein in recombination batches and thus be utilized to create completely new amylases and proteases or other polypeptides.

The goal is to introduce deliberate mutations, such as substitutions, insertions or deletions, into the known molecules so as to improve, for example, the cleaning performance of enzymes as contemplated herein. For this purpose, in particular the surface charges and/or the isoelectric point of the molecules, and thereby the interactions thereof with the substrate, can be modified. For example, the net charge of the enzymes can be modified so as to thereby influence substrate binding, in particular for the use in washing and cleaning agents. As an alternative or in addition, the stability of the amylase or protease can be increased by one or more appropriate mutations, and thereby the cleaning performance thereof can be improved. Advantageous properties of individual mutations, for example of individual substitutions, may complement one another. An amylase or protease that has already been optimized with respect to certain properties, for example with respect to the stability thereof to surfactants and/or bleaching agents and/or other components, can thus additionally be further developed as contemplated herein.

The following convention applies to the description of substitutions that relate to precisely one amino acid position (amino acid exchanges): initially, the naturally present amino acid is denoted in the form of the internationally customary single letter code, then follows the associated sequence position, and finally the inserted amino acid. Several exchanges within the same polypeptide chain are separated from one another by forward slashes. In the case of insertions, additional amino acids are named following the sequence position. In the case of deletions, the missing amino acid is replaced with a symbol, for example a star or a dash. For example, A95G describes the substitution of alanine at position 95 with glycine, A95AG describes the insertion of glycine after the amino acid alanine at position 95, and A95* describes the deletion of alanine at position 95. This nomenclature is known to a person skilled in the field of enzyme technology.

A further subject matter of the present disclosure is thus a washing and cleaning agent comprising a combination of an α-amylase and a protease, wherein the α-amylase is characterized by being obtainable from an amylase as contemplated herein as the starting molecule by one or more conservative amino acid substitutions. The expression “conservative amino acid substitution” refers to the exchange (substitution) of one amino acid residue for another amino acid residue, wherein this exchange does not result in a change in the polarity or charge at the position of the exchanged amino acid, such as the exchange of a non-polar amino acid residue for another non-polar amino acid residue. Conservative amino acid substitutions as contemplated herein include, for example: G=A=S, I=V=L=M, D=E, N=Q, K=R, Y=F, S=T, G=A=I=V=L=M=Y=F=W=P=S=T.

A further subject matter of the present disclosure is thus a washing and cleaning agent comprising a combination of an α-amylase and a protease, wherein the α-amylase is characterized by being obtainable from an amylase as contemplated herein as the starting molecule by way of fragmentation, deletion mutagenesis, insertion mutagenesis or substitution mutagenesis and comprises an amino acid sequence that agrees with the starting molecule over a length of at least about 50, about 60, about 70, about 80, about 90, about 100, about 110, about 120, about 130, about 140, about 150, about 160, about 170, about 180, about 190, about 200, about 210, about 220, about 230, about 240, about 250, about 260, about 270, about 280, about 290, about 300, about 310, about 320, about 330, about 340, about 350, about 360, about 370, about 380, about 390, about 400, about 410, about 420, about 430, about 440, about 450, about 460, about 470, about 475, about 480, about 482, about 484 or about 485 contiguous amino acids.

It is thus possible, for example, to delete individual amino acids at the termini or in the loops of the enzyme, without the proteolytic activity thereby being lost or decreased. Furthermore, such fragmentation, deletion mutagenesis, insertion mutagenesis or substitution mutagenesis can also be used to lower the allergenicity of the enzymes in question, and thus the overall usability can be improved. Advantageously, the enzymes preserve the proteolytic activity thereof even after the mutagenesis, which is to say the proteolytic activity thereof corresponds at least to that of the starting enzyme. Substitutions can also exhibit advantageous effects. Both individual and several contiguous amino acids can be exchanged with other amino acids.

An amylase as contemplated herein can additionally be stabilized, in particular by one or more mutations, such as substitutions, or by coupling to a polymer. An increase in stability during storage and/or during use, for example during the washing process, causes the enzymatic activity to last longer, whereby the cleaning performance is improved. In principle, all stabilization options described in the prior art and/or expedient may be used. Preferred stabilizations are those achieved by way of mutations of the enzyme itself, since such stabilizations do not require further work steps subsequent to the production of the enzyme. Suitable sequence changes for this purpose are known from the related art.

Further options for stabilization are, for example:

changing the binding of metal ions, and in particular of the calcium binding sites, for example by exchanging one or more of the amino acids involved in calcium binding with one or more negatively charged amino acids and/or by introducing sequence modifications in at least one of the following two amino acids arginine/glycine;

protection against the influence of denaturing agents such as surfactants by mutations that bring about a change in the amino acid sequence on or at the surface of the protein;

exchanging amino acids close to the N-terminus with such that presumably make contact with the residue in the molecule via non-covalent interaction and thus contribute to the preservation of the globular structure.

Preferred embodiments are those in which the enzyme is stabilized in several ways since multiple stabilizing mutations have an additive or synergistic effect.

A further subject matter as contemplated herein is an amylase as described above, which is characterized by comprising at least one chemical modification. An amylase comprising such a modification is referred to as a derivative, which is to say the amylase is derivatized.

Derivatives, within the meaning of the present application, shall thus be understood to mean those proteins in which the pure amino acid chain has been chemically modified. Such derivatizations can take place in vivo by the host cell expressing the protein, for example. In this regard, couplings of low molecular weight compounds, such as of lipids or oligosaccharides, shall be particularly emphasized. However, derivatizations can also be carried out in vitro, such as by chemically converting a side chain of an amino acid or by the covalent binding of a different compound to the protein. For example, it is possible to couple amines to carboxyl groups of an enzyme so as to change the isoelectric point. Such a different compound may also be a further protein, which is bound to a protein as contemplated herein, for example by way of bifunctional chemical compounds. Derivatization shall likewise be understood to mean the covalent binding to a macromolecular carrier, or also a non-covalent inclusion in suitable macromolecular cage structures. Derivatizations can influence the substrate specificity or the binding strength to the substrate, for example, or cause temporary blocking of the enzymatic activity, if the coupled substance is an inhibitor. This can be useful, for example, for the storage duration. Such modifications can furthermore influence the stability or the enzymatic activity. Furthermore, they can also be used to lower the allergenicity and/or immunogenicity of the protein and thereby, for example, increase the skin tolerability of the same. For example, couplings with macromolecular compounds, such as polyethylene glycol, can improve the protein in terms of stability and/or skin tolerability.

In the broadest sense, derivatives of a protein as contemplated herein can also be understood to mean preparations of these proteins. Depending on production, processing or preparation, a protein may be combined with various other substances, for example from the culture of the producing microorganisms. A protein may also have been deliberately mixed with other substances, for example to increase the storage stability thereof. All preparations of a protein as contemplated herein are thus also covered by the disclosure. This holds true regardless of whether or not the protein indeed develops this enzymatic activity in a certain preparation. It may be desirable for the protein to have no, or only low, activity during storage and to develop the enzymatic function thereof only at the time of use. This can be controlled by way of appropriate accompanying substances, for example.

The subject matter as contemplated herein includes all conceivable washing or cleaning agent types, both concentrates and agents to be employed undiluted, for use on a commercial scale, in the washing machine or during hand washing or cleaning. This includes, for example, washing agents for textiles, carpets, or natural fibers, for which the term washing agents is used. This also includes, for example, dishwasher detergents for dishwashers or manual dishwashing agents or cleaners for hard surfaces such as metal, glass, porcelain, ceramic, tiles, stone, painted surfaces, plastic materials, wood or leather, for which the term cleaning agents is used, which is to say in addition to manual dishwashing agents and automatic dishwasher detergents, for example, also scouring agents, glass cleaners, scented automatic toilet bowl cleaners and the like. As contemplated herein, the washing and cleaning agents furthermore include washing auxiliaries, which are dosed to the washing agent proper when washing textiles manually or automatically so as to achieve further action. Washing and cleaning agents as contemplated herein furthermore also include textile pre- and after-treatment agents, which is to say agents with which the piece of laundry is brought in contact prior to the actual washing process, for example to partially loosen stubborn stains, and also agents that impart further desirable properties, such as a pleasant feel, crease resistance, or low static electricity, to the item to be washed in a step downstream from the actual textile washing process. The agents mentioned last include fabric softeners, for example.

The washing or cleaning agents as contemplated herein can comprise further enzymes. Further enzymes that can be used are, for example, lipases or cutinases, in particular for the triglyceride-liberating activities thereof, but also so as to create peroxy acids in situ from suitable precursors. These include, for example, the lipases which were originally obtainable or further developed from Humicola lanuginosa (Thermomyces lanuginosus), in particular those including the D96L amino acid exchange. These include, for example, the lipases that are originally obtainable or further developed from Humicola lanuginosa (Thermomyces lanuginosus), in particular those including one or more of the following amino acid exchanges proceeding from the above-mentioned lipase at positions D96L, T213R and/or N233R, and particularly preferably T213R and N233R. Furthermore, it is possible, for example, to use cutinases that originally were isolated from Fusarium solani pisi and Humicola insolens. Furthermore, it is possible to use lipases or cutinases in which the starting enzymes were originally isolated from Pseudomonas mendocina and Fusarium solanii.

The agents as contemplated herein can also comprise cellulases or hemicellulases such as mannanases, xanthan lyases, pectin lyases (=pectinases), pectin esterases, pectate lyases, xyloglucanases (=xylanases), pullulanases or β-glucanases.

To enhance the bleaching action, oxidoreductases as contemplated herein, for example oxidases, oxygenases, catalases, peroxidases, such as haloperoxidases, chloroperoxidases, bromoperoxidases, lignin peroxidases, glucose peroxidases or manganese peroxidases, dioxygenases or laccases (phenol oxidases, polyphenol oxidases) may be used. Advantageously, preferably organic, and particularly preferably aromatic, compounds that interact with the enzymes are additionally added so as to enhance the activity of the particular oxidoreductases (enhancers), or so as to ensure the electron flux in the event of large differences in the redox potentials between the oxidizing enzymes and the stains (mediators).

Amylases can also be used as further enzymes, all above-described amylases being suitable.

In addition to the above-described ingredients, the washing or cleaning agents can comprise substances providing cleaning action, wherein substances from the group consisting of the surfactants, builders, polymers, glass corrosion inhibitors, corrosion inhibitors, fragrances and perfume carriers are preferred. These preferred ingredients will be described in more detail hereafter.

One preferred component of the washing or cleaning agents as contemplated herein are the non-ionic surfactants, wherein non-ionic surfactants of the general formula R¹—CH(OH)CH₂O-(AO)_{w}-(A′O)ₓ-(A″O)_{y}-(A″ΔO)_{z}—R², in which

R1¹ denotes a straight-chain or branched, saturated, monounsaturated or polyunsaturated C₆₋₂₄ alkyl functional group or alkenyl residue;

R² denotes a linear or branched hydrocarbon functional group having from about 2 to about 26 carbon atoms;

A, A′, A″ and A′″, independently of one another, denote a functional group from the group consisting of —CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃); and

w, x, y and z denote values between 0.5 and 120, wherein x, y and/or z may also be 0, are preferred.

By adding the aforementioned non-ionic surfactants of the general formula R¹—CH(OH)CH₂O-(AO)_{w}-(A′O)ₓ-(A″O)_{y}-(A′″O)_{z}—R², hereafter also referred to as “hydroxy mixed ethers,” the cleaning performance of enzyme-containing preparations as contemplated herein can be significantly improved, and more particularly both in comparison with surfactant-free systems and in comparison with systems that comprise alternative non-ionic surfactants, such as from the group of the polyalkoxylated fatty alcohols.

By using these non-ionic surfactants having one or more free hydroxyl group at one or both terminal alkyl functional groups, the stability of the enzymes present in the washing or cleaning agent preparations as contemplated herein can be considerably improved.

Preferred are, in particular, those end-capped poly(oxyalkylated) non-ionic surfactants which, according to formula R¹O[CH₂CH₂O]ₓCH₂CH(OH)R², in addition to a functional group R¹ denoting linear or branched, saturated or unsaturated, aliphatic or aromatic hydrocarbon functional groups having 2 to 30 carbon atoms, and preferably having 4 to 22 carbon atoms, furthermore comprise a linear or branched, saturated or unsaturated, aliphatic or aromatic hydrocarbon functional group R² having 1 to 30 carbon atoms, wherein x denotes values between 1 and 90, preferably values between 30 and 80, and in particular values between 30 and 60.

Particularly preferred are surfactants of formula R¹O[CH₂CH(CH₃)O]ₓ[CH₂CH₂O]_{y}CH₂CH(OH)R², in which R¹ denotes a linear or branched, aliphatic hydrocarbon functional group having 4 to 18 carbon atoms or mixtures thereof, R² denotes a linear or branched hydrocarbon functional group having 2 to 26 carbon atoms or mixtures thereof, x denotes values between 0.5 and 1.5, and y denotes a value of at least 15. The group of these non-ionic surfactants includes, for example, the C₂₋₂₆ fatty alcohol-(PO)₁-(EO)₁₅₋₄₀-2-hydroxyalkyl ethers, and in particular also the C₈₋₁₀ fatty alcohol-(PO)₁-(EO)₂₂-2-hydroxydecyl ethers.

Particularly preferred are furthermore those end-capped poly(oxyalkylated) non-ionic surfactants of formula R¹O[CH₂CH₂O]ₓ[CH₂CH(R³)O]_{y}CH₂CH(OH)R², in which R¹ and R², independently of one another, denote a linear or branched, saturated, monounsaturated or polyunsaturated hydrocarbon functional group having 2 to 26 carbon atoms, R³, independently of one another, is selected from —CH₃, —CH₂CH₃, —CH₂CH₂—CH₃, —CH(CH₃)₂, preferably however is —CH₃, and x and y, independently of one another, denote values between 1 and 32, wherein non-ionic surfactants where R³=—CH₃ and values for x are from 15 to 32 and for y from 0.5 to 1.5 are especially particularly preferred.

Further non-ionic surfactants that may preferably be used are the end-capped poly(oxyalkylated) non-ionic surfactants of formula R¹O[CH₂CH(R³)O]ₓ[CH₂]ₖCH(OH)[CH₂]ⱼOR², in which R¹ and R² denote linear or branched, saturated or unsaturated, aliphatic or aromatic hydrocarbon functional groups having 1 to 30 carbon atoms, R³ denotes H or a methyl, ethyl, n-propyl, iso-propyl, n-butyl, 2-butyl or 2-methyl-2-butyl functional group, x denotes values between 1 and 30, and k and j denote values between 1 and 12, and preferably between 1 and 5. When the value x≧2, each R³ in the above formula R¹O[CH₂CH(R³)O]ₓ[CH₂]ₖCH(OH)[CH₂]ⱼOR² may be different. R¹ and R² are preferably linear or branched, saturated or unsaturated, aliphatic or aromatic hydrocarbon functional groups having 6 to 22 carbon atoms, wherein functional groups having 8 to 18 carbon atoms are particularly preferred. H, CH₃ or —CH₂CH₃ are particularly preferred for the functional group R³. Particularly preferred values for x are in the range of 1 to 20, and in particular of 6 to 15.

As described above, each R³ in the above formula may be different when x≧2. In this way, the alkylene oxide unit in the square brackets may be varied. For example, when x is 3, then the functional group R³ may be selected so as to form ethylene oxide—(R³=H) or propylene oxide—(R³=CH₃) units, which may be joined to one another in any arbitrary order, for example (EO)(PO)(EO), (EO)(EO)(PO), (EO)(EO)(EO), (PO)(EO)(PO), (PO)(PO)(EO) and (PO)(PO)(PO). The value 3 for x has been selected by way of example here and may certainly also be larger, wherein the variation range increases with increasing x values and, for example, includes a large number of (EO) groups, combined with a low number of (PO) groups, or vice versa.

Particularly preferred end-capped poly(oxyalkylated) alcohols of the above formula have values of k=1 and j=1, whereby the above formula is simplified to R¹O[CH₂CH(R³)O]ₓ[CH₂CH(OH)[CH₂OR². In the last formula, R¹, R² and R³ are as defined above, and x denotes numbers from 1 to 30, preferably from 1 to 20, and in particular 6 to 18. Particularly preferred are surfactants in which the functional groups R¹ and R² comprise 9 to 14 carbon atoms, R³ denotes H, and x takes on values from 6 to 15.

Finally, non-ionic surfactants that have proven to be particularly effective are those of the general formula R¹—CH(OH)CH₂O-(AO)_{w}—R² in which

R1¹ denotes a straight-chain or branched, saturated, monounsaturated or polyunsaturated C₆₋₂₄ alkyl functional group or alkenyl residue;

R² denotes a linear or branched hydrocarbon functional group having 2 to 26 carbon atoms;

A denotes a functional group from the group consisting of CH₂CH₂, —CH₂CH₂CH₂, —CH₂CH(CH₃), and

w denotes values between 1 and 120, preferably 10 to 80, and in particular 20 to 40. The group of these non-ionic surfactants includes, for example, the C₄₋₂₂ fatty alcohol-(EO)₁₀₋₈₀-2-hydroxyalkyl ethers, and in particular also the C₈₋₁₂ fatty alcohol-(EO)₂₂-2-hydroxydecyl ethers and the C₄₋₂₂ fatty alcohol-(EO)₄₀₋₈₀-2-hydroxyalkyl ethers

Preferred washing or cleaning agents are characterized in that the washing or cleaning agent comprises at least one non-ionic surfactant, and preferably a non-ionic surfactant from the group of the hydroxy mixed ethers, wherein the percent by weight of the non-ionic surfactant, based on the total weight of the washing or cleaning agent, is especially from about 0.2 to about 10 wt. %, preferably from about 0.4 to about 7.0 wt. %, and in particular from about 0.6 to about 6.0 wt. %.

Preferred washing or cleaning agents as contemplated herein for use in automatic dishwashing methods comprise further surfactants, and in particular amphoteric surfactants, in addition to the above-described non-ionic surfactants. The percent of the anionic surfactants, based on the total weight of these washing or cleaning agents, however, is preferably limited. Preferred automatic dishwasher detergents, for example, are characterized by comprising, based on the total weight thereof, less than about 5.0 wt. %, preferably less than about 3.0 wt. %, and particularly preferably less than about 2.0 wt. % anionic surfactant. The use of anionic surfactants in larger amounts is dispensed with, in particular to avoid excessive foam development.

A further preferred component of washing or cleaning agents as contemplated herein is complexing agents. Phosphonates are particularly preferred complexing agents. In addition to 1-hydroxyethane-1,1-diphosphonic acid, the complexing phosphonates comprise a number of different compounds, such as diethylenetriamine penta(methylene phosphonic acid) (DTPMP). In particular, hydroxyalkane or aminoalkane phosphonates are preferred in the present application. Among the hydroxyalkanephosphonates, 1-hydroxyethane-1,1-diphosphonate (HEDP) is of particular importance as a cobuilder. It is preferably used as a sodium salt, wherein the disodium salt reacts in a neutral fashion, and the tetrasodium salt acts in an alkaline manner (pH 9). Possible preferred aminoalkane phosphonates include ethylenediaminetetramethylene phosphonate (EDTMP), diethylenetriaminepentamethylene phosphonate (DTPMP) and the higher homologs thereof. They are preferably used in the form of the neutrally reacting sodium salts, for example as the hexasodium salt of EDTMP or as the hepta- and octasodium salt of DTPMP. Of the class of phosphonates, HEDP is preferably used as a builder. The aminoalkane phosphonates additionally have a pronounced capability to bind heavy metals. Accordingly, it may preferred, in particular if the agents also include bleach, to use aminoalkanephosphonates, in particular DTPMP, or mixtures of the cited phosphonates.

A preferred washing or cleaning agents within the scope of the present application comprises one or more phosphonates from the group consisting of:
a) aminotrimethylene phosphonic acid (ATMP) and/or the salts thereof;
b) ethylenediamine tetra(methylene phosphonic acid) (EDTMP) and/or the salts thereof;
c) diethylenetriamine penta(methylene phosphonic acid) (DTPMP) and/or the salts thereof;
d) 1-hydroxyethane-1,1-diphosphonic acid (HEDP) and/or the salts thereof;
e) 2-phosphonobutane-1,2,4-tricarboxylic acid (PBTC) and/or the salts thereof;
f) hexamethylenediamine tetra(methylene phosphonic acid) (HDTMP) and/or the salts thereof; and
g) nitrilotris(methylene phosphonic acid) (NTMP) and/or the salts thereof.

Particularly preferred are washing or cleaning agents that comprise 1-hydroxyethane-1,1-diphosphonic acid (HEDP) or diethylenetriamine penta(methylene phosphonic acid) (DTPMP) as phosphonates. The washing or cleaning agents as contemplated herein can, of course, comprise two or more different phosphonates. Preferred washing or cleaning agents as contemplated herein are characterized in that the washing or cleaning agent comprises at least one complexing agent from the group of the phosphonates, and preferably 1-hydroxyethane-1,1-diphosphonate, wherein the percent by weight of the phosphonate, based on the total weight of the washing or cleaning agent, is especially from about 0.1 to about 8.0 wt. %, preferably from about 0.2 to about 5.0 wt. %, and in particular from about 0.5 to about 3.0 wt. %.

The washing or cleaning agents as contemplated herein furthermore preferably comprise builders. The builders include in particular the silicates, carbonates, organic cobuilders and—where ecological bias against their use is absent—also phosphates. Organic cobuilder substances can be present in amounts of up to 40 wt. %, in particular up to 25 wt. %, and preferably from about 1 wt. % to about 8 wt. %, if desired.

Among the plurality of commercially available phosphates, alkali metal phosphates have the greatest significance for the agents as contemplated herein, pentasodium triphosphate, Na₅P₃O₁₀ (sodium tripolyphosphate) or pentapotassium tripolyphosphate, K₅P₃O₁₀ (potassium tripolyphosphate) being particularly preferred. If phosphates are used as substances providing cleaning action in the washing or cleaning agent within the scope of the present application, preferred agents comprise this phosphate or these phosphates, preferably pentapotassium triphosphate, wherein the percent by weight of the phosphate, based on the total weight of the washing or cleaning agent, is especially from about 5.0 to about 40.0 wt. %, preferably from about 10 to about 30 wt. %, and in particular from about 12 to about 25 wt. %.

In particular, polycarboxylates/polycarboxylic acids, polymeric polycarboxylates, aspartic acid, polyacetals, dextrins, further organic cobuilders and phosphonates shall be mentioned as organic cobuilders. These substance classes are described hereafter.

Usable organic builder substances are, for example, the polycarboxylic acids that can be used in the form of the free acids and/or of the sodium salts thereof, wherein polycarboxylic acids shall be understood to mean those carboxylic acids that carry more than one acid function. These include, for example, citric acid, adipic acid, succinic acid, glutaric acid, malic acid, tartaric acid, maleic acid, fumaric acid, saccharic acids, aminocarboxylic acids, nitrilotriacetic acid (NTA), provided that such use is not objectionable for ecological reasons, and mixtures thereof. In addition to the builder effect, the free acids typically also have the property of being an acidifying component and are thus also used to set a lower and milder pH value of washing or cleaning agents. In particular, citric acid, succinic acid, glutaric acid, adipic acid, gluconic acid and arbitrary mixtures of these shall be mentioned here. Citric acid or salts of citric acid are particularly preferably used as builder substances. Further particularly preferred builder substances are selected from methylglycine diacetic acid (MGDA), glutamine diacetic acid (GLDA), aspartic acid diacetate (ASDA), hydroxyethyl-iminodiacetate (HEIDA), iminodisuccinate (IDS), ethylenediamine disuccinate (EDDS), carboxymethyl inulin and poly aspartate.

Builders moreover include polymeric polycarboxylates; for example, these are the alkali metal salts of polyacrylic acid or of polymethacrylic acid, for example those having a relative molar mass from about 500 to about 70000 g/mol.

Within the meaning of this application, the molar masses indicated for the polymeric polycarboxylates are weight average molar masses M_{w} of the respective acid form, which in general were determined by way of gel permeation chromatography (GPC), wherein a UV detector was used. The measurement was carried out against an external polyacrylic acid standard, which due to the structural relationship to the examined polymers supplies realistic molecular weight values. This information deviates considerably from the molecular weight information in which the standard used is polystyrene sulfonic acids. The molar masses measured against polystyrene sulfonic acids are generally considerably higher than the molar masses indicated in the present application.

Suitable polymers are in particular polyacrylates, which preferably have a molar mass from about 2000 to about 20000 g/mol. Due to the superior solubility thereof, short-chain polyacrylates having molar masses from about 2000 to about 10000 g/mol, and particularly preferably from about 3000 to about 5000 g/mol, may in turn be preferred from this group.

Also suitable are copolymeric polycarboxylates, in particular those of acrylic acid with methacrylic acid, and of acrylic acid or methacrylic acid with maleic acid. Copolymers of acrylic acid with maleic acid, comprising from about 50 to about 90 wt. % acrylic acid and from about 50 to about 10 wt. % maleic acid, have proven to be particularly suitable. The relative molecular mass thereof, based on free acids, is generally from about 2000 to about 70000 g/mol, preferably from about 20000 to about 50000 g/mol, and in particular from about 30000 to about 40000 g/mol.

Oxydisuccinates and other derivatives of disuccinates, preferably ethylenediamine disuccinate, are further suitable cobuilders. For this purpose, ethylenediamine-N,N′-disuccinate (EDDS) is preferably used in the form of the sodium or magnesium salts thereof. Furthermore, glycerol disuccinates and glycerol trisuccinates are preferred in this context.

So as to improve the cleaning performance and/or set the viscosity, preferred washing or cleaning agents comprise at least one hydrophobically modified polymer, and preferably a hydrophobically modified carboxylic acid group-containing polymer, wherein the percent by weight of the hydrophobically modified polymer, based on the total weight of the washing or cleaning agent, is especially from about 0.1 to about 10 wt. %, preferably between about 0.2 and about 8.0 wt. %, and in particular from about 0.4 to about 6.0 wt. %.

In addition to the above-described builders, polymers providing cleaning action can be present in the washing or cleaning agent. The percent by weight of the polymers providing cleaning action, based on the total weight of automatic washing or cleaning agents as contemplated herein, is especially from about 0.1 to about 20 wt. %, preferably from about 1.0 to about 15 wt. %, and in particular from about 2.0 to about 12 wt. %.

Preferably, sulfonic acid-group containing polymers, and in particular from the group of the copolymeric polysulfonates, are used as polymers providing cleaning action. In addition to sulfonic acid group-containing monomer(s), these copolymeric polysulfonates comprise at least one monomer from the group of the unsaturated carboxylic acids.

Particularly preferably, unsaturated carboxylic acids of formula R¹(R²)C═C(R³)COOH are used as unsaturated carboxylic acid(s), in which R¹ to R³, independently of one another, denote —H, —CH_{3,} a straight-chain or branched saturated alkyl functional group having 2 to 12 carbon atoms, a straight-chain or branched, monounsaturated or polyunsaturated alkenyl residue having 2 to 12 carbon atoms, alkyl functional groups or alkenyl residues substituted with —NH₂, —OH or —COOH as defined above, or —COOH or —COOR⁴, wherein R⁴ is a saturated or unsaturated, straight-chain or branched hydrocarbon functional group having from about 1 to about 12 carbon atoms.

Particularly preferred unsaturated carboxylic acids are acrylic acid, methacrylic acid, ethacrylic acid, α-chloroacrylic acid, α-cyanoacrylic acid, crotonic acid, α-phenylacrylic acid, maleic acid, maleic anhydride, fumaric acid, itaconic acid, citraconic acid, methylene malonic acid, sorbic acid, cinnamic acid or the mixtures thereof. It is also possible, of course, to use the unsaturated dicarboxylic acids.

Among the sulfonic acid group-containing monomers, those of formula R⁵(R⁶)C═C(R⁷)—X—SO₃H are preferred, in which R⁵ to R⁷, independently of one another, denote —H, —CH_{3,} a straight-chain or branched saturated alkyl functional group having from about 2 to about 12 carbon atoms, a straight-chain or branched, monounsaturated or polyunsaturated alkenyl residue having from about 2 to about 12 carbon atoms, alkyl functional groups or alkenyl residues substituted with —NH₂, OH or —COOH, or —COOH or COOR⁴, wherein R⁴ is a saturated or unsaturated, straight-chain or branched hydrocarbon functional group having from about 1 to about 12 carbon atoms, and X denotes an optionally present spacer group which is selected from —(CH₂)ₙ— where n=0 to 4, —COO—(CH₂)ₖ— where k=1 to 6, —C(O)—NH—C(CH₃)₂—, —C(O)—NH—C(CH₃)₂—CH₂— and —C(O)—NH—CH(CH₂CH₃)—.

Among these monomers, those of formulas H₂C═CH—X—SO₃H, H₂C═C(CH₃)—X—SO₃H and HO₃S—X—(R⁶)C═C(R⁷)—X—SO₃H are preferred in which R⁶ and R⁷, independently of one another, are selected from —H, —CH₃, —CH₂CH₃, —H₂CH₂CH₃, —CH(CH₃)₂, and X denotes an optionally present spacer group, which is selected from —(CH₂)ₙ— where n=0 to 4, —COO—(CH₂)ₖ— where k=1 to 6, —C(O)—NH—C(CH₃)₂—, —C(O)—NH—C(CH₃)₂—CH₂— and —C(O)—NH—CH(CH₂CH₃)—.

Particularly preferred sulfonic acid group-containing monomers are 1-acrylamido-1-propanesulfonic acid, 2-acrylamido-2-propanesulfonic acid, 2-acrylamido-2-methyl-1-propanesulfonic acid, 2-methacrylamido-2-methyl-1propanesulfonic acid, 3-methacrylamido-2-hydroxypropanesulfonic acid, allylsulfonic acid, methallylsulfonic acid, allyloxybenzesulfonic acid, methallyloxybenzenesulfonic acid, 2-hydroxy-3-(2-propenyloxy)propanesulfonic acid, 2-methyl-2-propenesulfonic acid, styrenesulfonic acid, vinylsulfonic acid, 3-sulfopropylacrylate, 3-sulfopropylmethacrylate, sulfomethacrylamide, sulfomethylmethacrylamide, and mixtures of the described acids or the water-soluble salts thereof.

The sulfonic acid groups can be present entirely or partially in neutralized form in the polymers. The use of partially or fully neutralized sulfonic acid group-containing copolymers is preferred as contemplated herein.

The molar mass of the preferably used sulfo copolymers as contemplated herein can be varied so as to adapt the properties of the polymers to the desired intended purpose. Preferred automatic dishwasher detergents are characterized in that the copolymers have molar masses of from about 2000 to about 200,000 g/mol⁻¹, preferably of from about 4000 to about 25,000 g/mol⁻¹, and in particular of from about 5000 to about 15000 g/mol⁻¹.

In a further preferred embodiment, the copolymers also comprise at least one non-ionic, preferably hydrophobic, monomer, in addition to the carboxyl group-containing monomer and the sulfonic acid group-containing monomer. Through the use of these hydrophobically modified polymers, it was possible to improve, in particular, the rinsing performance of automatic dishwasher detergents as contemplated herein.

A washing or cleaning agent, comprising a copolymer comprising:
i) carboxylic acid group-containing monomer(s)
ii) sulfonic acid group-containing monomer(s)
iii) non-ionic monomer(s)
   are preferred as contemplated herein. Through the use of these terpolymers, it was possible to improve the rinsing performance of automatic dishwasher detergents as contemplated herein over comparable dishwasher detergents comprising sulfo polymers without the addition of non-ionic monomers.

Preferably, the non-ionic monomers used are monomers of general formula (R¹)(R²)C═C(R³)—X—R⁴, in which R¹ to R³, independently of one another, denote H, —CH₃ or —C₂H₅, X denotes an optionally present spacer group which is selected from —(CH₂)—, —C(O)O— and —C(O)—NH—, and R⁴ denotes a straight-chain or branched saturated alkyl functional group having 2 to 22 carbon atoms, or an unsaturated, preferably aromatic, functional group having 6 to 22 carbon atoms.

Particularly preferred non-ionic monomers are butene, isobutene, pentene, 3-methylbutene, 2-methylbutene, cyclopentene, hexene, hexene-1, 2-methlypentene-1,3-methlypentene-1,cyclohexene, methylcyclopentene, cycloheptene, methylcyclohexene, 2,4,4-trimethylpentene-1,2,4,4-trimethylpentene-2,2,3-dimethylhexene-1,2,4-diemthylhexene-1,2,5-dimethlyhexene-1,3,5 -dimethylhexene-1,4,4-dimethylhexane-1,ethylcyclohexyn, 1-octene, α-olefins comprising 10 or more carbon atoms, such as 1-decene, 1-dodecene, 1-hexadecene, 1-octadecene and C22-α-olefin, 2-styrene, α-methylstyrene, 3-methylstyrene, 4-propylstryene, 4-cyclohexylstyrene, 4-dodecylstyrene, 2-ethyl-4-benzylstyrene, 1-vinylnaphthalene, 2-vinylnaphthalene, acrylic acid methyl ester, acrylic acid ethyl ester, acrylic acid propyl ester, acrylic acid butyl ester, acrylic acid pentyl ester, acrylic acid hexyl ester, methacrylic acid methyl ester, N-(methyl)acrylamide, acrylic acid-2-ethylhexyl ester, methacrylic acid-2-ethylhexyl ester, N-(2-ethylhexyl)acrylamide, acrylic acid octyl ester, methacrylic acid octyl ester, N-(octyl)acrylamide, acrylic acid lauryl ester, methacrylic acid lauryl ester, N-(lauryl)acrylamide, acrylic acid stearyl ester, methacrylic acid stearyl ester, N-(stearyl)acrylamide, acrylic acid behenyl ester, methacrylic acid behenyl ester and N-(behenyl)acrylamide, or the mixtures thereof.

The percent by weight of the sulfonic acid group-containing copolymers, based on the total weight of washing or cleaning agents as contemplated herein, is preferably from about 0.1 to about 15 wt. %, preferably from about 1.0 to about 12 wt. %, and in particular from about 2.0 to about 10 wt. %.

The washing or cleaning agents as contemplated herein can be present in formulation forms known to a person skilled in the art, which is to say, for example, in solid or liquid form, or as a combination of solid and liquid presentation forms. Suitable solid presentation forms are, in particular, powders, granules, extrudates or compactates, in particular tablets.

A substance, such as a composition or an agent, is solid according to the definition as contemplated herein if it is present in the solid state of aggregation at 25° C. and 1013 mbar.

A substance, such as a composition or an agent, is liquid according to the definition as contemplated herein if it is present in the liquid state of aggregation at 25° C. and 1013 mbar. Liquid shall also cover gel-like.

In addition to the enzymes as contemplated herein, solid, and in particular powdered, washing or cleaning agents as contemplated herein can, in principle, comprise all known ingredients customary in such agents, wherein at least one further ingredient is present in the agent. The agents as contemplated herein can, in particular, comprise builder substances, surface-active surfactants, bleaching agents based on organic and/or inorganic peroxygen compounds, bleach activators, water-miscible organic solvents, enzymes, sequestering agents, electrolytes, pH regulators and further auxiliary agents, such as optical brighteners, graying inhibitors, foam regulators, dyes and fragrances, and combinations thereof.

In one embodiment, a washing or cleaning agent furthermore comprises:

from about 5 wt. % to about 70 wt. %, and in particular from about 5 wt. % to about 30 wt. % surfactants and/or

from about 10 wt. % to about 65 wt. %, and in particular from about 12 wt. % to about 60 wt. % water-soluble or water-dispersible inorganic builder material and/or

from about 0.5 wt. % to about 10 wt. %, and in particular from about 1 wt. % to about 8 wt. % water-soluble organic builder substances and/or

from about 0.01 to about 15 wt. % solid inorganic and/or organic acids or acid salts and/or

from about 0.01 to about 5 wt. % complexing agents for heavy metals and/or

from about 0.01 to about 5 wt. % graying inhibitors and/or

from about 0.01 to about 5 wt. % dye transfer inhibitors and/or

from about 0.01 to about 5 wt. % suds suppressors.

Optionally, the agent can furthermore comprise optical brighteners, preferably from about 0.01 to about 5 wt. %.

The production of solid agents as contemplated herein does not pose any difficulties and be carried out in the known manner, for example by spray drying or granulation, wherein enzymes and potential further thermally sensitive ingredients, such as bleaching agents, are optionally added separately later. To produce agents as contemplated herein having increased bulk density, in particular in the range from about 650 g/L to about 950 g/L, a method comprising an extrusion step is preferred.

So as to produce solid agents as contemplated herein in tablet form, which can be single-phase or multiphase, single-color or multi-color and in particular can be composed of one layer or of multiple, in particular of two, layers, the procedure is preferably such that all components—optionally of a respective layer—are mixed with one another in a mixer, and the mixture is compressed using conventional tablet presses, such as eccentric presses or rotary presses, using pressures in the range of approximately 50 to 100 kN, preferably from about 60 to about 70 kN. In particular in the case of multi-layer tablets, it may be advantageous if at least one layer is pre-compressed. This is preferably carried out at pressures between about 5 and about 20 kN, and in particular at from about 10 to about 15 kN. This readily yields break-resistant tablets that nonetheless dissolve sufficiently quickly under usage conditions, with breaking and flexural strengths of normally from about 100 to about 200 N, preferably however above 150 N. A tablet thus produced preferably has a weight of from about 10 g to about 50 g, and in particular of from about 15 g to about 40 g. The physical shape of the tablets is arbitrary and can be round, oval or angular, intermediate shapes also being possible. Corners and edges are advantageously rounded. Round tablets preferably have a diameter of from about 30 mm to about 40 mm. In particular, the size of angular or cuboid tablets, which are predominantly introduced via the dosing device, for example of the dishwasher, is dependent on the geometry and the volume of this dosing device. Preferred embodiments by way of example have a base area of (20 to 30 mm)×(34 to 40 mm), and in particular of 26×36 mm or of 24×38 mm.

A solid agent as contemplated herein preferably contains at least one water-soluble and/or water-insoluble, organic and/or inorganic builder. The water-soluble organic builder substances include the above-described organic builders.

In particular, alkali silicates, alkali carbonates and alkali phosphates, which can be present in the form of the alkaline, neutral or acidic sodium or potassium salts, can be used as water-soluble inorganic builder materials. Examples in this regard are described above in the present application.

Water-dispersible inorganic builder materials for solid agents are, in particular, crystalline or amorphous alkali aluminosilicates, used in amounts of up to about 50 wt. %, preferably not above 40 wt. % and, in liquid agents, in particular in amounts from about 1 wt. % to about 5 wt. %. Among these, the crystalline sodium aluminosilicates in washing agent quality, in particular zeolite A, P and optionally X, either alone or in mixtures, for example in the form of a co-crystallizate of the zeolites A and X (Vegobond® AX, a commercial product of Condea Augusta S.p.A.), are preferred. Amounts close to the aforementioned upper limit are preferably used for solid, particulate agents. Suitable aluminosilicates, in particular, comprise no particles having a particle size above 30 μm, and preferably have a content of at least about 80 wt. % of particles having a size of less than 10 μm. The calcium binding capacity, which can be determined in accordance with information found in the German patent specification DE 24 12 837, is generally in the range of from about 100 to about 200 mg CaO per gram.

Suitable substitutes or partial substitutes for the aforementioned aluminosilicate are crystalline alkali silicates, which can be present alone or in a mixture with amorphous silicates. The alkali silicates that can be used as builders in the agents as contemplated herein preferably have a molar ratio of alkali oxide to SiO₂ of less than about 0.95, in particular of from about 1:1.1 to about 1:12 and can be present in amorphous or crystalline form. Preferred alkali silicates are sodium silicates, in particular the amorphous sodium silicates, having a molar ratio of Na2O:SiO2 of 1:2 to 1:2.8. Crystalline silicates, which may be present either alone or in a mixture with amorphous silicates, that are used are preferably crystalline phyllosilicates of general formula Na₂SiₓO₂ₓ₊₁·y H₂O, where x, the so-called module, is a number from about 1.9 to about 22, and in particular from about 1.9 to about 4, and y is a number from 0 to 33, and preferred values for x are 2, 3 or 4. Preferred crystalline phyllosilicates are those in which x in the above-mentioned general formula takes on the value 2 or 3. In particular, both β- and δ-sodium disilicates (Na₂Si₂O₅·y H₂O) are preferred. Practically anhydrous crystalline alkali silicates, produced from amorphous alkali silicates, of the above general formula, in which x denotes a number from about 1.9 to about 2.1, can also be used in agents as contemplated herein. In a further preferred embodiment of agents as contemplated herein, a crystalline sodium phyllosilicate having a module from about 2 to about 3 is used, as it can be produced from sand and soda. Crystalline sodium silicates having a module in the range from about 1.9 to about 3.5 are used in a further preferred embodiment of agents as contemplated herein. Crystalline phyllosilicates of the above formula (I) are sold by Clariant GmbH under the trade name Na-SKS, such as Na-SKS-1 (Na₂Si₂₂O₄₅·xH₂O, kenyaite), Na-SKS-2 (Na₂Si₁₄O₂₉.H₂O, magadiite), Na-SKS-3 (Na₂Si₈O₁₇.H₂O) or Na-SKS-4 (Na₂Si₄O₉.H₂O, makatite). Among these, especially Na-SKS-5 (α-Na₂Si₂O₅), Na-SKS-7 (β-Na₂Si₂O, natrosilite), Na-SKS-9 (NaHSi₂O₅·3H₂O), Na-SKS-10 (NaHSi₂O₅·3H₂O, kanemite), Na-SKS-11 (t-Na₂Si₂O₅) and Na-SKS-13 (NaHSi₂O₅) are suitable, in particular however Na-SKS-6 (δ-Na₂Si₂O₅). In a preferred embodiment of agents as contemplated herein, a granular compound made of crystalline phyllosilicate and citrate, crystalline phyllosilicate and the above-described (co)polymeric polycarboxylic acid, or alkali silicate and alkali carbonate is used, as it is commercially available under the name Nabion® 15, for example.

Builders are preferably present in the solid agents as contemplated herein in amounts of up to about 75 wt. %, and in particular of from about 5 wt. % to about 50 wt. %.

Possible peroxygen compounds suitable for use in the solid agents as contemplated herein include, in particular, organic peroxy acids or peracid salts of organic acids, such as phthalimidopercaproic acid, perbenzoic acid, or salts of diperdodecanoic diacid, hydrogen peroxide and inorganic salts giving off hydrogen peroxide under the usage conditions, which include perborate, percarbonate, persilicate and/or persulfate such as caroate. To the extent that solid peroxygen compounds are to be used, these may be used in the form of powders or granules, which may also be coated in the manner known per se. If an agent as contemplated herein comprises peroxygen compounds, these are preferably present in amounts of up to about 50 wt. %, and in particular of from about 5 wt. % to about 30 wt. %. The addition of small amounts of known bleaching agent stabilizers, such as phosphonates, borates or metaborates and metasilicates, as well as magnesium salts, such as magnesium sulfate, can be advantageous.

Compounds that, under perhydrolysis conditions, yield aliphatic peroxocarboxylic acids having preferably 1 to 10 carbon atoms, and in particular 2 to 4 carbon atoms, and/or optionally substituted perbenzoic acid, can be used as bleach activators in the solid agents. Suitable substances are those that carry O— and/or N-acyl groups having the described carbon atomic number and/or optionally substituted benzoyl groups. Polyacylated alkylene diamines, in particular tetra acetyl ethylene diamine (TAED), acylated triazine derivatives, in particular 1,5-diacetyl-2,4-dioxohexahydro-1,3.5-triazine (DADHT), acylated glycolurils, in particular tetraacetyl glycoluril (TAGU), N-acylimides, in particular N-nonanoyl succinimide (NOSI), acylated phenolsulfonates, in particular n-nonanoyl or iso-nonanoyl oxybenzene sulfonate (n- or iso-NOBS), carboxylic acid anhydrides, in particular phthalic anhydride, acylated polyhydric alcohols, in particular triacetin, ethylene glycol diacetate, 2,5-diacetoxy-2,5-dihydrofuran and enol esters, as well as acetylated sorbitol and mannitol and the described mixtures thereof (SORMAN), acylated sugar derivatives, in particular penta-acetyl glucose (PAG), penta-acetyl fructose, tetra-acetyl xylose and octa-acetyl lactose, as well as acetylated, optionally N-alkylated glucamine and gluconolactone, and/or N-acylated lactams, for example N-benzoyl caprolactam, are preferred. The hydrophilically substituted acyl acetals and the acyl lactams are likewise preferably used. It is also possible to use combinations of conventional bleach activators. Such bleach activators can, in particular in the presence of the above-mentioned hydrogen peroxide-yielding bleaching agents, be present in the customary quantity range, preferably in amounts of from about 0.5 wt. % to about 10 wt. %, and in particular from about 1 wt. % to about 8 wt. %, based on the total agent, but preferably are entirely absent when percarboxylic acid is used as the sole bleaching agent.

In addition to the conventional bleach activators or instead of these, it is also possible for sulfonimines and/or bleach-boosting transition metal salts or transition metal complexes to be present as so-called bleach catalysts.

The solid forms of application as contemplated herein include extrudates, granules, tablets or pouches comprising solid agents, which can be present both in large packages or packaged into portions. As an alternative, the agent is present in the form of a pourable powder, in particular having a bulk density of from about 300 g/L to about 1200 g/L, and in particular from about 500 g/L to about 900 g/L, or from about 600 g/L to about 850 g/L.

Embodiments of the present disclosure include all solid, powdered, liquid, gel or pasty forms of application of the agents, which optionally can also consist of multiple phases and can be present in compressed or uncompressed form. Thus, agents that are characterized by being present in the form of a monocomponent system represent another embodiment as contemplated herein. Such agents preferably consist of one phase. Agents as contemplated herein, however, can of course also be composed of multiple phases, for example two liquid phases, two solid phases, or one liquid and one solid phase. In a further embodiment as contemplated herein, the washing or cleaning agent is thus characterized by being divided into multiple components.

The liquid presentation forms based on water and/or organic solvents can be present in thickened form, in the form of gels.

The washing or cleaning agents as contemplated herein are preferably present in liquid form. Preferred washing or cleaning agents comprise, based on the total weight thereof, more than about 40 wt. %, preferably between 5 about 0 and about 90 wt. %, and in particular between about 60 and about 80 wt. % water.

The washing or cleaning agents as contemplated herein can comprise an organic solvent as a further component. The addition of organic solvents has an advantageous effect on the enzyme stability and cleaning performance of these agents. Preferred organic solvents come from the group of monohydric or polyhydric alcohols, alkanolamines or glycol ethers. The solvents are preferably selected from ethanol, n- or i-propanol, butanol, glycol, propanediol or butanediol, glycerol, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether or monoethyl ether, methoxytriglycol, ethoxytriglycol, butoxytriglycol, 1-butoxyethoxy-2-propanol, 3-methyl-3-methoxy butanol, propylene glycol t-butyl ether, and mixtures of these solvents. The percent by weight of these organic solvents, based on the total weight of washing or cleaning agents as contemplated herein, is especially from about 0.1 to about 10 wt. %, preferably from about 0.2 to about 8.0 wt. %, and in particular from about 0.5 to about 5.0 wt. %. A particularly preferred organic solvent, which is particularly effective with respect to the stabilization of the washing or cleaning agents, is glycerol and 1,2-propylene glycol. Liquid washing or cleaning agents that comprise at least one polyol, preferably from the group consisting of glycerol and 1,2-propylene glycol, wherein the percent by weight of the polyol, based on the total weight of the washing or cleaning agent, is especially from about 0.1 to about 10 wt. %, preferably from about 0.2 to about 8.0 wt. %, and in particular from about 0.5 to about 5.0 wt. %, are preferred as contemplated herein.

Organic amines and alkanolamines are further preferred organic solvents. The washing or cleaning agents as contemplated herein comprise these amines especially in amounts of from about 0.1 to about 10 wt. %, preferably of from about 0.2 to about 8.0 wt. %, and in particular of from about 0.5 to about 5.0 wt. %, in each case based on the total weight of the agents. Ethanolamine is a particularly preferred alkanolamine.

A further preferred component of the washing or cleaning agents as contemplated herein is a sugar alcohol (alditol). The group of the alditols comprises non-cyclic polyols of formula HOCH₂[CH(OH)]ₙCH₂OH. The alditols include, for example, mannitol, isomalt, lactitol, sorbitol, xylitol, threitol, erythritol and arabinitol. Sorbitol has proven to be particularly advantageous with respect to the enzyme stability. The percent by weight of the sugar alcohol, based on the total weight of washing or cleaning agent, is especially from about 1.0 to about 10 wt. %, preferably from about 2.0 to about 8.0 wt. %, and in particular from about 3.0 to about 6.0 wt. %.

Liquid washing or cleaning agents as contemplated herein are preferably formulated in multiphase form, which is to say by combining two or more different liquid washing or cleaning agents that are separated from one another. This type of formulation increases the stability of the washing or cleaning agent and improves the cleaning performance thereof. A preferred washing or cleaning agents as contemplated herein is characterized by comprising a packaging component and two liquid washing or cleaning agents A and B, which are present separated from each other in this packaging component, wherein composition A comprises:
a) at least one modified protease as contemplated herein;
b) at least one further enzyme different from the protease as contemplated herein;
c) from about 10 to about 84.9 wt. % builder(s);
d) from about 15 to about 89.9 wt. % water; and composition B comprises:
e) from about 10 to about 75 wt. % builders; and
f) from about 25 to about 90 wt. % water.

A further subject matter as contemplated herein is a method for cleaning textiles or hard surfaces, which is characterized in that an agent as contemplated herein is used in at least one method step.

This covers both manual and automatic methods, wherein automatic methods are preferred. Methods for cleaning textiles are generally characterized in that, in multiple method steps, different substances providing cleaning action are applied to the product to be cleaned and washed off following the application time, or that the product to be cleaned is treated in another manner with a washing agent or a solution or dilution of this agent. The same applies to methods for cleaning all materials other than textiles, and in particular hard surfaces. All conceivable washing or cleaning methods can be enhanced in at least one of the method steps with the use of a washing or cleaning agent as contemplated herein, or a combination as contemplated herein of amylase and protease, and then represent embodiments of the present disclosure. All content, subject matter and embodiments that are described for the combination as contemplated herein of amylase and protease and agents comprising the same can also be applied to this subject matter as contemplated herein. Express reference is therefore made at this point to the disclosure provided elsewhere, noting that this disclosure also applies to the above-described methods as contemplated herein.

Alternative embodiments of the present subject matter as contemplated herein also include methods for treating textile raw materials or for the care of textile, in which a protease as contemplated herein becomes active in at least one method step. Among these, methods for textile raw materials, fibers or textiles comprising natural components are preferred, and especially particular for those comprising wool or silk.

A further subject matter as contemplated herein is the use of an agent as contemplated herein for cleaning textiles or hard surfaces, in particular in such a way that the combination of amylase and protease is used in an amount of from about 4 μg to about 4 g, preferably of from about 5 μg to about 3 g, particularly preferably of from about 10 μg to about 2 g, and especially particularly preferably of from about 20 μg to about 1 g.

All content, subject matter and embodiments that are described for the proteases as contemplated herein and agents comprising the same can also be applied to this subject matter as contemplated herein. Express reference is therefore made at this point to the disclosure provided elsewhere, noting that this disclosure also applies to the above-described use as contemplated herein.

### EXAMPLE

The following example describes the disclosure, without limiting it to this example.

Examination of the combinations as contemplated herein of amylase and protease in the washing machine

Textiles soiled with standardized stains were used for this example. The following soiling was used:

blood/milk/ink on cotton: product no. C-05 available from CFT (Center For Testmaterials) B. V. Viaardingen, Netherlands

The combination as contemplated herein of the protease according to SEQ ID NO. 4 and an amylase as contemplated herein (batch 1), and a comparative batch containing the protease according to SEQ ID NO. 4 and Stainzyme® (batch 2) were washed for comparison in the washing machine, wherein the washing experiments were made once directly after the washing agent was formulated (0 weeks) and once after the washing agent had been stored for 16 weeks (16 weeks).

In each case, the same amount of active enzyme as used. The proteases and amylases were dosed on top to an aqueous liquid washing agent (containing, in addition to water, 5.5 wt. % 7-fold ethoxylated C12/14 fatty alcohol, 5.3 wt. % sodium-C9-13 alkylbenzene sulfonate, 4.9 wt. % sodium-C12/14 fatty alcohol ether sulfate comprising 2 EO, 1.8 wt. % citric acid, 3 wt. % C12-18 fatty acid, 0.1 wt. % diethylenetriamine penta(methylene phosphonic acid)-hepta sodium salt, 1.3 wt. % NaOH, 3.6 wt. % ethanol/glycerol) having a pH of 8.5, and washed at 30° C., water hardness 16° dH. in a Miele W 1935, total washing time 70 minutes. A 6-fold determination was carried out, and various stain monitors were washed and measured with a colorimeter after washing.

The following delta Y values were obtained for Batch 1 compared to Batch 2:

| Storage time (weeks) | delta Y values (Batch 1-Batch 2) |
|---|---|
| 0 | 2.1 |
| 16 | 3.2 |

It is clearly apparent that the washing performance of the washing agent comprising the protease according to SEQ ID NO. 4 and the amylase as contemplated herein is significantly higher both after 0 weeks and after 16 weeks. In particular, a greater effect is apparent after a storage period of 16 weeks, which additionally allows the conclusion that the protease is stabilized by the amylase as contemplated herein.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

1. A washing or cleaning agent, comprising a combination of an α-amylase and a protease, wherein the α-amylase is at least about 89% identical to the sequence indicated in SEQ ID NO. 1 over the entire length thereof and, in the numbering according to SEQ ID NO. 1, has deletions at one or more of positions 180, 181, 182, 183 and 184.

2. The washing or cleaning agent according to claim 1, wherein the amylase comprises deletions at two or more, selected from the positions 180+181, 181+182, 182+83 and 183+184, in the numbering according to SEQ ID NO. 1.

3. The washing or cleaning agent according to claim 1, wherein the amylase comprises the deletions H183*+G184*, in the numbering according to SEQ ID NO. 1.

4. The washing or cleaning agent according to claim 1, wherein the amylase further comprises amino acid substitutions at one or more of positions 405, 421, 422 and 428, in the numbering according to SEQ ID NO. 1.

5. The washing or cleaning agent according to claim 1, wherein the amylase comprises the substitutions I405L, A421H, A422P and A428T, in the numbering according to SEQ ID NO. 1.

6. The washing or cleaning agent according to claim 1, wherein the protease comprises an amino acid sequence that is at least about 80% identical to the amino acid sequence indicated in SEQ ID NO. 2 and/or in SEQ ID NO, 3 over the total length thereof.

7. The washing or cleaning agent according to claim 6, wherein the protease comprises an amino acid sequence that is at least about 80% identical to the amino acid sequence indicated in SEQ ID NO. 2 over the total length thereof and comprises the amino acid glutamic acid (E) at position 99, in the numbering according to SEQ ID NO. 2.

8. The washing or cleaning agent according to claim 1, wherein the protease is a protease according to SEQ ID NO. 4.

9. The washing or cleaning agent according to claims 1, wherein the protease is present in the washing or cleaning agent in an amount of from about 0.001 to about 0.1 wt. % based on the total weight of the washing or cleaning agent.

10. A washing or cleaning agent according to claim 1 wherein the washing or cleaning agent is utilized for washing textiles or cleaning hard surfaces.

11. A method for cleaning textiles or hard surfaces, the method comprising utilizing the washing or cleaning agent according to claim 1.

12. The washing or cleaning agent according to claim 2, wherein the amylase comprises deletions at positions 183+184, in the numbering according to SEQ ID NO. 1.

13. The washing or cleaning agent according to claim 6, wherein the protease comprises an amino acid sequence that is at least about 80% identical to the amino acid sequence indicated in SEQ ID NO. 2 over the total length thereof.

14. The washing or cleaning agent according to claim 13, wherein the protease comprises an amino acid sequence that is at least about 90% identical to the amino acid sequence indicated in SEQ ID NO. 2 over the total length thereof.

15. The washing or cleaning agent according to claim 14, wherein the protease comprises an amino acid sequence that is at least about 95% identical to the amino acid sequence indicated in SEQ ID NO. 2 over the total length thereof.

16. The washing or cleaning agent according to claim 6, wherein the protease comprises an amino acid sequence that is at least about 80% identical to the amino acid sequence indicated in SEQ ID NO. 3 over the total length thereof.

17. The washing or cleaning agent according to claim 16, wherein the protease comprises an amino acid sequence that is at least about 90% identical to the amino acid sequence indicated in SEQ ID NO. 3 over the total length thereof.

18. The washing or cleaning agent according to claim 17, wherein the protease comprises an amino acid sequence that is at least about 95% identical to the amino acid sequence indicated in SEQ ID NO. 3 over the total length thereof.

19. The washing or cleaning agent according to claim I, wherein the α-amylase is at least about 95% identical to the sequence indicated in SEQ NO. 1 over the entire length thereof.

20. The washing or cleaning agent according to claim 1, wherein the protease is present in the washing or cleaning agent in an amount of from about 0.005 to about 0.012 wt. %, based on the total weight of the washing or cleaning agent.


SEQUENCE LISTING (4 sequences)

SEQ ID NO: 1 - protein, 485 aa, Artificial
  Hybridprotein
HHNGTNGTMMQYFEWYLPNDGNHWNRLNSDASNLKSKGITAVWIPPAWKGASQNDVGYGAYDLYDLGEFNQKGTVRTKYGTRSQLQAAVTSLKNNGIQVYGDVVMNHKGGADATEMVRAVEVNPNNRNQEVTGEYTIEAWTRFDFPGRGNTHSSFKWRWYHFDGVDWDQSRRLNNRIYKFRGHGKAWDWEVDTENGNYDYLMYADIDMDHPEVVNELRNWGVWYTNTLGLDGFRIDAVKHIKYSFTRDWINHVRSATGKNMFAVAEFWKNDLGAIENYLQKTNWNHSVFDVPLHYNLYNASKSGGNYDMRNIFNGTVVQRHPSHAVTFVDNHDSQPEEALESFVEEWFKPLAYALTLTREQGYPSVFYGDYYGIPTHGVPAMRSKIDPILEARQKYAYGPQHDYIDHPDVIGWTREGDSSAAKSGLAALITDGPGGSKRMYAGLKNAGETWYDITGNRSDTVKIGSDGWGEFHVNDGSVSIYVQK

SEQ ID NO: 2 - protein, 269 aa, Bacillus lentus
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGADGRGAISSIAQGLEWAGNNGMHVANLSLGSPSPSATLEQAVNSATSRGVLVVAASGNSGASSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 3 - protein, 275 aa, Bacillus amyloliquefaciens [sequence omitted]

SEQ ID NO: 4 - protein, 269 aa, Artificial
  BLAP R99E
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGADGEGAISSIAQGLEWAGNNGMHVANLSLGSPSPSATLEQAVNSATSRGVLVVAASGNSGASSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR